(19) United States
(12) Patent Application Publication
(10) Pub. No.: US 2022/0014067 A1
(43) Pub. Date: Jan. 13, 2022

(54) INTERCONNECTION ARRANGEMENT FOR AN ELECTRICAL MACHINE

(71) Applicant: ZF FRIEDRICHSHAFEN AG, Friedrichshafen (DE)

(72) Inventors: Jochen WITTMANN, Burkardroth (DE); Christoph WIEDER, Küps (DE); Matthias CUDOK, Ritschenhausen (DE)

(21) Appl. No.: 17/280,100

(22) PCT Filed: Sep. 25, 2019
(86) PCT No.: PCT/EP2019/075924

§ 371 Date: Mar. 25, 2021

(30) Foreign Application Priority Data
Sep. 26, 2018 (DE) 10 2018 216 463.0

(51) Int. Cl. H02K 3/52; H02K 15/04

(52) U.S. Cl. CPC H02K 3/522; H02K 2203/09; H02K 15/0421

(57) ABSTRACT

An interconnection for an electric machine with hairpin winding, having a plurality of connection pins, the interconnection includes connection conductors that extend over a portion of the circumference in each instance. The interconnection has a carrier that supports the connection conductors and insulates the connection conductors relative to one another. Each connection pin is electrically conductively connected to a connection conductor. The carrier has supporting arms at the outer circumference thereof, in that the supporting arms are inclined relative to a radially extending plane as well as relative to a rotational axis of the electric machine, and the supporting arms have clamping surfaces by which they are clampable between a housing or stator carrier and a bearing shield.

### CROSS REFERENCE TO RELATED APPLICATIONS

This is a U.S. national stage of Application No. PCT/EP2019/075924 filed Sep. 25, 2019. Priority is claimed on German Application No. DE 10 2018 216 463.0 filed Sep. 26, 2018 the content of which is incorporated herein by reference.

### BACKGROUND OF THE INVENTION

### 1. Field of the Invention

The present disclosure is directed to an interconnection arrangement for an electric machine with a winding formed of a plurality of shaped rods that pass through at least two slots spaced apart in circumferential direction and which have contact points on one side of the electric machine connected to one another to form the winding. Windings of this kind are also referred to as hairpin windings or wave windings. In the following, only the designation “hairpin” or “hairpin winding” will be used, with wave windings and the like being comprehended within the meaning of the application.

### 2. Description of Related Art

It is known in the prior art in windings of electric machines, particularly of the stator, to connect the plurality of connection pins at the winding head via corresponding conductors in accordance with the polarity required for the coils of the winding. In the prior art, the connection pins are connected to one another directly or via an additional conductor, and the interconnection is generally only connected to the winding. It is known from US 2007/0278876 A1 to support the interconnection via projections at the stator. It is known from DE 11 2012 007 017 T5 to provide springing elements that press a separately formed interconnection in direction of the winding.

Problems result in the prior art from the forces acting on the connection between connection pins and conductors in electric machines, above all in mobile applications such as use in vehicles. The acting forces due to vibrations, impact loads and the like may result in damage to the connection and, therefore, in failure of the electric machine.

### SUMMARY OF THE INVENTION

It is the object of one aspect of the present invention to provide an interconnection that is produced simply and quickly and offers a reliable connection over the usable period of the electric machine.

According to one aspect of the invention, an interconnection for an electric machine with hairpin winding, wherein the hairpin winding has a plurality of connection pins, wherein the interconnection comprises a plurality of connection conductors that extend at least over a portion of the circumference in each instance, wherein the interconnection has a carrier that supports the connection conductors and at least insulates the connection conductors relative to one another, and wherein each connection pin is electrically conductively connected to a connection conductor, is characterized in that the carrier has a plurality of supporting arms at the outer circumference thereof, in that the supporting arms are inclined relative to a radially extending plane, and in that the supporting arms have clamping surfaces by which they are clampable between a housing or stator carrier and a bearing shield.

A hairpin winding is formed from a plurality of hairpins or shaped rods having contact points at the ends thereof at the winding head. The contact points are electrically conductively connected to one another in pairs to produce the coils of the hairpin winding from the hairpins. The contact points, which are connected to one another in pairs are referred to as hairpin ends, and the respective individual contact points at the start and end of the respective coils are referred to as connection pins. The connection pins are electrically conductively connected to an interconnection in order to connect to the power electronics for controlling the electric machine.

To operate an electric machine, the coils—depending on construction—must be correspondingly connected, respectively, to a phase or a neutral conductor, which are generally controlled via power electronics. An interconnection which comprises connection conductors is provided so that the power electronics can, if need be, supply a plurality of coils or, more accurately, a plurality of connection pins with a common contact. Every connection conductor is connected to a phase of the power electronics or to the neutral conductor. Depending on the construction of the electric machine, the connection pins are electrically conductively connected to one of the connection conductors, respectively, in a corresponding manner and a plurality of connection pins can be connected to the same connection conductor.

The connection conductors extend in each instance in circumferential direction at least over a partial area so that connection pins protruding from the hairpin winding can be connected to the corresponding connection conductor. The partial area in circumferential direction preferably comprises at least the angle between connection pins of the same phase. In order to increase stability and to facilitate handling, the connection conductors and/or the carrier in which the connection conductors are received can also extend over the entire circumference.

The carrier receives the connection conductors and comprises an electrically insulating material. For this purpose, the carrier can be deformed and have corresponding receptacle areas for the connection conductors in which the latter are inserted. The connection conductors are preferably fixed in the carrier, which can be carried out, for example, by catches or separate fastening elements. It is also possible that the carrier is formed of multiple parts and the connection conductors are enclosed and held by the mounting of the individual parts of the carrier. Alternatively, it is preferably also possible that the connection conductors are overmolded directly with the carrier by an injection molding process, i.e., the carrier is formed directly at least partially encompassing the connection conductors in a primary-shaping process. The connection conductors are insulated from one another by the material of the carrier disposed between the connection conductors.

At its outer circumference, the carrier has a plurality of supporting arms by which the carrier and, therefore, the interconnection are positioned inside of the electrical machine. The supporting arms protrude from the carrier in radial direction and are inclined relative to a radially extending plane of the electric machine. At least three supporting arms distributed relatively uniformly over the circumference are preferably provided to prevent tilting. A larger quantity of supporting arms can preferably also be provided to reduce the load acting on the individual supporting arms. Within the meaning of the present application, the plurality of supporting arms can also form a circumferential flange extending along the entire circumference. The supporting arms are inclined relative to a radially extending plane in order to absorb forces possibly acting during operation both in radial direction and in axial direction at least partially as tensile-compressive stress and accordingly, at the same time, to substantially prevent or minimize elastic deformations due to a springing effect.

The supporting arms can be oriented identically; but it is also possible that the supporting arms are variously inclined relative to the carrier.

Clamping surfaces are provided at the supporting arms by which the supporting arms are clampable between a housing or stator carrier and a bearing shield of the electric machine. The clamping surfaces are provided at the supporting arms, respectively, on both axial sides. All of the clamping surfaces in one direction, for example, clamping surfaces facing the hairpin winding, preferably lie on a radial or conical plane so as to facilitate receiving and clamping between the parts of the housing. The supporting arms preferably have a uniform thickness at least in the region of the clamping surfaces. This also facilitates the clamping between parts of the housing of the electric machine. When the supporting arms are variously inclined, they can be variously positioned in axial direction at the carrier in a corresponding manner. Alternatively, the clamping surfaces in one direction can also be positioned on different planes, for example, in order that they can serve as positioning aids during assembly. In this case, the housing parts can also be formed in a corresponding manner.

Embodiment forms of an interconnection are characterized in that the clamping surfaces are arranged parallel to or on a radially extending plane. If the clamping surfaces extend in radial direction, plane end faces which are simpler to produce than inclined arrangements can be correspondingly provided at the housing parts. As has already been stated, it is preferable that the clamping surfaces of one direction lie on a plane. It is also possible that the clamping surfaces are provided in axial direction at different locations and are arranged parallel to one another.

Interconnections according to embodiment forms are characterized in that at least some of the clamping surfaces have at least one projection, which is deformable in order to compensate for manufacturing tolerances during assembly. The projections are axially protruding regions located between the housing part and clamping surface during assembly and are deformed by assembly forces. An axial height of the projections is preferably less than or equal to the thickness of the supporting arms in the region of the clamping surfaces, and a projection has a smaller extension at least in a direction lying in a radial plane. This ensures that the projections can deform. As a result of the deformation, manufacturing tolerances can be compensated particularly with respect to the axial length of the housing parts and the axial run-out thereof. The projections may be located on only one side of the supporting arms or on both sides of the supporting arms; preferably, at least one clamping surface has at least one projection per supporting arm. The projections can be provided as local structures such as points and the like or also as linear structures in the form of ribs and the like.

In embodiment forms, interconnections are characterized in that the connection conductors run coaxially or in axial direction parallel to one another. The connection conductors are arranged adjacent to one another, and insulating material of the carrier is disposed therebetween.

Interconnections according to embodiment forms are characterized in that the connection conductors are formed annularly extending over the entire circumference. The connection conductors accordingly have the shape of an annular disk or a sleeve. Because of this configuration, the connection conductors with insulation located therebetween due to the carrier can be arranged as annular disks stacked in axial direction or as coaxial sleeves so that connection conductors with a sufficiently large conducting cross section can be provided in a relatively compact installation space.

Embodiment forms of an interconnection are characterized in that the connection conductors have contact points in the radially inner region or radially outer region which protrude from the carrier for connecting to the connection pin. The connection conductors have contact points extending in radial direction from the carrier for contacting the connection pins with the connection conductors. In this regard, the contact points are preferably formed integral with the respective connection conductor. Alternative configurations in which the contact points are formed as separate component parts connected to the connection conductor are also possible.

Preferred embodiment forms of an interconnection are characterized in that the contact points in each instance run axially parallel to a connection pin at least in a partial area. For a simpler connection of the connection pins to the contact points, the latter run parallel to the connection pins at least in the area of the connection. To this end, for example, the contact points can be reshaped, particularly bent, in axial direction out of a radial plane of the connection conductor. In this regard, the contact points of the different connection conductors are preferably formed to vary in length so that the axial areas of the contact points lie in the same axial portion after reshaping.

Interconnections in embodiment forms are characterized in that the carrier wraps around the connection conductors to form a positive engagement. In order to position and hold the connection conductors securely in the carrier, the connection conductors can be surrounded by the carrier to form a positive engagement. This wrapping around to form a positive engagement is preferably carried out by a catch connection or snap-in connection which can engage behind an edge or a cutout provided in the connection conductors. In this regard, a plurality of catch connections can cooperate, respectively, directly with the respective connection conductor. Alternatively, the carrier may also be formed of a plurality of parts and the at least two parts of the carrier can be connected to one another via corresponding catch connections which accordingly wrap around the connection conductors to form a positive engagement. As a result of the catch connections or snap-in connections, the component parts can be joined quickly and simply and the connection is detachable.

Embodiment forms of an interconnection are characterized in that the carrier is produced by overmolding the connection conductors. When a carrier is produced from plastic, this carrier can also be formed in that the connection conductors positioned relative to one another can be inserted in a mold and overmolded directly with the material of the carrier. Accordingly, the carriers are produced directly around the connection conductors during the primary shaping. Manufacturing steps are saved in this way.

A further aspect of the invention is an electric machine with a hairpin winding which is characterized in that an interconnection according to one of the described embodiment forms is provided and in that the clamping surfaces are clamped between a housing or stator carrier and a bearing shield of the electric machine. Accordingly, the electric machine has the advantages of the interconnection which were described above and, owing to the arrangement of the clamping surfaces between the housing and a bearing cap, the interconnection is securely accommodated in the housing and a loading of the interconnection by forces occurring in operation is absorbed by the supporting arms and the housing and not transmitted to the hairpin winding.

Electric machines in further embodiment forms are characterized in that the hairpin winding has hairpin ends, which are welded to one another, in that the hairpin ends are covered by an insulating unit, and in that the interconnection lies on the insulating unit. The welded ends of the hairpin winding must be sufficiently insulated with respect to one another, for which reason an insulating unit is provided on the welded hairpin ends. The interconnection is electrically conductively connected to the connection pins of the hairpin winding. For simpler assembly, the interconnection is placed on the insulating unit so that the insulating unit is held and positioned at the same time by the interconnection, especially after the clamping surfaces are clamped between the housing and bearing shield.

Positioning and handling can be appreciably facilitated by using an insulating unit as independent component part. The insulating unit has a base body that comprises an electrically insulating material. Plastic is preferably used as material, but embodiment forms with other electrically insulating materials such as rubber or other elastic materials or ceramic materials are also possible. The base body may be formed of one or more parts and extends at least over a portion of the circumference. Depending on the construction, the distances between the connection pins and hairpin ends, particularly in the area of the connection pins, can be shorter, or the distance from hairpin ends to other electrically conductive component parts can also be short at other locations on the circumference, for which reason insulation is required especially in these areas. Therefore, depending on the construction of the electric machine, embodiment forms are possible in which it is sufficient that only a portion of the circumference of the hairpin winding is covered by the insulating unit. However, preferred embodiment forms have a base body on which the entire circumference of the hairpin winding and hairpin ends is covered.

In order to insulate the hairpin ends from one another, the base body viewed in axial direction of the electric machine has openings that extend across the thickness of the base body and are accordingly continuous. Because of the continuous openings, air can escape during a potting of the hairpin ends so that trapped air and the like can be reliably prevented. At the same time, insulation of the hairpin ends relative to one another, particularly with respect to the air gap, is improved by the material of the base body present between the openings. Every opening is associated with a hairpin end or a contact pair comprising conductor elements, which are welded together or a connection pin.

Embodiment forms of an insulating unit of an electric machine are characterized in that the base body has, at its side remote of the hairpin winding, spacers which serve as spacers for an interconnection. In order to prevent the continuous openings from being closed by a mounted interconnection or other component parts, for example, spacers are provided at the base body which ensure a minimum distance between the end face of the base body with the openings and an adjacent component part. This ensures that the openings will remain passable even during potting, for example, after the interconnection has been mounted and connected, and that potting compound and air can escape through the openings.

Preferred insulating units are characterized in that the spacers are arranged so as to be uniformly distributed over the circumference. A uniform distribution ensures the minimum spacing over the entire circumference, and symmetries can be utilized.

Insulating units according to further preferred embodiment forms are characterized in that the spacers are not arranged directly adjacent to an opening for a connection pin. When an interconnection is connected to a connection pin, a directly adjacent spacer may lead to an unwanted diminution of the creepage distance for the insulation. Therefore, there are preferably no spacers provided at the material of the base body directly surrounding an opening for a connection pin; rather, the spacers are arranged between openings for hairpin ends.

The spacers at an insulating unit of an electric machine are preferably T-shaped. As a result of the T-shape, a reliable support can be ensured even in case of relatively few spacers, and tilting can be prevented even when supported at an individual spacer. Further, T-shaped spacers can be arranged easily between the openings.

A further aspect of the invention is a method for producing an electric machine with an interconnection as described above, which comprises providing a hairpin winding, positioning the interconnection on the hairpin winding, wherein supporting arms of the interconnection are positioned with their clamping surfaces on a housing or stator carrier, connecting the connection pins to the connection conductors, and mounting and connecting a bearing shield on the housing or stator carrier, wherein the supporting arms are clamped with their clamping surfaces between the housing or stator carrier and the bearing shield. As has already been stated, the supporting arms are clamped with their clamping surfaces between a housing and a bearing shield of the electric machine. Accordingly, the interconnection which has been connected beforehand to the hairpin winding is fixedly positioned inside the electric machine and forces possibly occurring in operation are transferred directly to the housing so as to prevent a relative movement between interconnection and hairpin winding and a loading of the connection between the interconnection and connection pins.

Methods according to embodiment forms are characterized in that an insulating unit is mounted on the hairpin winding before the interconnection, wherein the hairpin ends are positioned in the insulating unit and the connection pins are electrically conductively conducted to the interconnection axially through or past the insulating unit. To enable a connection between the interconnection and the connection pins, the insulating unit has continuous openings through which the connection pins are guided, or the connection pins are radially guided past the insulating unit or in cutouts provided at the circumferential surface.

Embodiment forms of a method are characterized in that a potting compound is applied before or after mounting the interconnection in order to insulate the hairpin ends.

As has already been stated with respect to the insulating unit and electric machine, the winding, in particular the winding of the stator of an electric machine, is initially provided. The insulating unit is positioned on the winding head of the hairpin winding to produce an alignment of the hairpin ends and the connection pins with respect to the openings and the interconnection. It is ensured by the continuous openings when introducing potting compound proceeding from an axial end of the openings that the air can escape from the opposite end of the opening and so that no air pockets occur. A uniform insulation of the hairpin ends is achieved in this way. The potting compound can be introduced before mounting the interconnection in order to provide an insulated winding head for the subsequent assembly step.

Alternatively, the potting compound can be introduced after mounting the interconnection. By potting after the interconnection is mounted, this interconnection can advantageously be potted together with the insulating unit. This has the advantage that when potted together an additional connection is carried out between the interconnection and insulating unit and an insulation of the interconnection, particularly of the connection pins and contact points, is produced at the same time.

The interconnection is preferably mounted on spacers provided at the insulating unit so that the interconnection is spaced apart from the insulating unit. This spacing prevents contact between the interconnection and the contact pairs. Further, the continuous openings of the insulating unit remain accessible from both axial ends across the spacing, which allows the potting compound to be introduced and air to escape.

### BRIEF DESCRIPTION OF THE DRAWINGS

The invention will be described more fully in the following referring to figures Like or similar component parts are designated by consistent reference numerals. In particular, the figures show:

FIG. 1 is a section through an embodiment form in the installed state;

FIG. 2 is a partial section of a perspective view of an embodiment form; and

FIG. 3 is a top view of an embodiment form of an interconnection.

### DETAILED DESCRIPTION OF THE PRESENTLY PREFERRED EMBODIMENTS

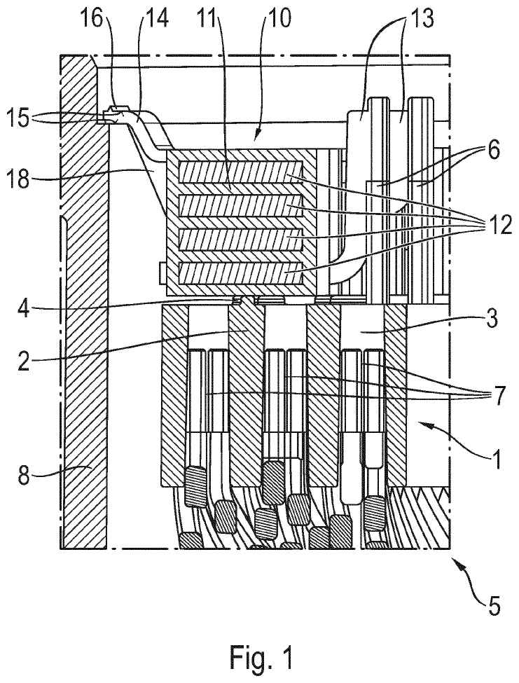

FIG. 1 shows an upper partial region of a stator with winding head in section. In this regard, the winding head 5 is the one hairpin winding in which a plurality of shaped rods are arranged with their contact ends correspondingly in pairs and are electrically conductively connected to one another so as to form the hairpin ends 7. As a result of the connections at the hairpin ends 7, the coils of the hairpin winding are formed from the shaped rods, these coils having individual connection pins 6 at the coil ends. The hairpin ends 7 are received in the continuous openings 3 of the base body 2 of the insulating unit. The hairpin ends 7 terminate inside the openings 3 and accordingly do not protrude over the base body 2. In contrast, the connection pins 6, which are also received in openings 3 protrude over the base body 2.

The connection pins 6 are connected to an interconnection 10, which is mounted on the insulating unit 1 and by which the various connection pins 6 are correspondingly interconnected to one another and to power electronics. In the depicted example, the interconnection 10 is formed from a plurality of connection conductors 12, which are arranged adjacent to one another in axial direction and are insulated with respect to one another and which have contact points 13 protruding in direction of the connection pins 6. The contact points 13 are electrically conductively connected, preferably welded, to the connection pins 6. The interconnection 10 can be constructed differently, for example, with coaxially arranged conductor sleeves, depending on the design of the electric machine.

The interconnection 10 is placed on the axial spacers 4 of the base body 2 of the insulating unit 1. The spacers 4 ensure that a free gap remains between the interconnection 10 and base body 2 so that when introducing a potting compound, not shown, air can escape from the openings 3 and potting compound can flow into the openings 3, respectively. In this way, it is ensured that no air pockets can form in the potting compound, which could reduce the insulating effect.

In the depicted example, the interconnection 10 comprises additional supporting arms 14 supported at the housing 8 of the electric machine in order to facilitate positioning of the interconnection 10. The supporting arms 14 extend at least partially at an inclination relative to an axial direction so as to improve stiffness relative to axial and radial forces. In this way, relative movements between the interconnection 10 and winding head 5 are prevented and mechanical loading of the connection between connection pin 6 and contact point 13 during operation is reduced. Alternatively or additionally, the supporting arms 14 can have stiffeners 18, for example, in the form of ribs or the like.

At their radially outer end, the supporting arms 14 have clamping surfaces 15 on the sides thereof located in axial direction. These clamping surfaces 15 are provided between contact surfaces of nonmoving component parts of the electric machine and are clamped thereby. In FIG. 1, a contact surface 15 lies on a shoulder of the housing 8 or of the stator carrier. During assembly of the electric machine, a bearing shield, not shown, is connected the housing 8. An abutment surface of this bearing shield, or a protruding annular shoulder which can also be utilized for centering, comes in contact with the opposite clamping surface 15 and accordingly fastens the latter.

In the depicted embodiment example, a projection 16 is provided on the clamping surface 15 remote of the housing 8. The projection 16 has a triangular cross section in FIG. 1, although other cross-sectional shapes are also possible. During assembly, the bearing shield initially comes in contact with the tip of the projection 16 and deforms the latter due to assembly forces. Any deviation in the component parts coming in contact with the clamping surfaces 15 because of manufacturing tolerances can be compensated by the projections 16, since a fastening of the interconnection 10 can already be achieved through contact with the projection 16 regardless of the degree to which the latter is deformed.

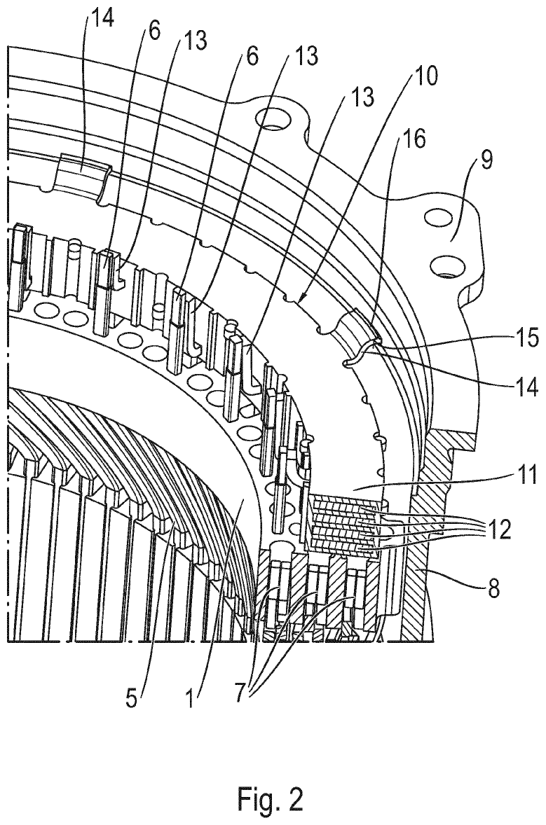

The embodiment example shown in FIG. 2 is formed substantially analogous to FIG. 1 and the preceding description may be referred to in this regard. FIG. 2 shows the flange 9 of the housing 8 to which a bearing shield, not shown, is screwed.

The supporting arms 14 are likewise arranged at the outer circumference in the axially upper region and extend upward at an inclination. It is also possible to arrange the supporting arms at the upper front side of the interconnection 10. Similarly, the supporting arms 14 can be provided so as to incline downward depending on the available installation space. The supporting arms 14 distributed along the circumference can also be provided at different locations such as at a different axial height at the circumferential region or different radii on the front side in order to provide different angles of inclination, distributed preferably symmetrically along the circumference, between supporting arm 14 and interconnection 10 or so as to conform to installation space restrictions.

In this instance, the projections 16 at the clamping surfaces 15 are provided at the end in radial direction. By arranging at the end, the material deformed during a deformation of the projections 16 can escape not only along the clamping surface 15 but also in possibly existing intermediate spaces in radial direction between supporting arm and housing 8.

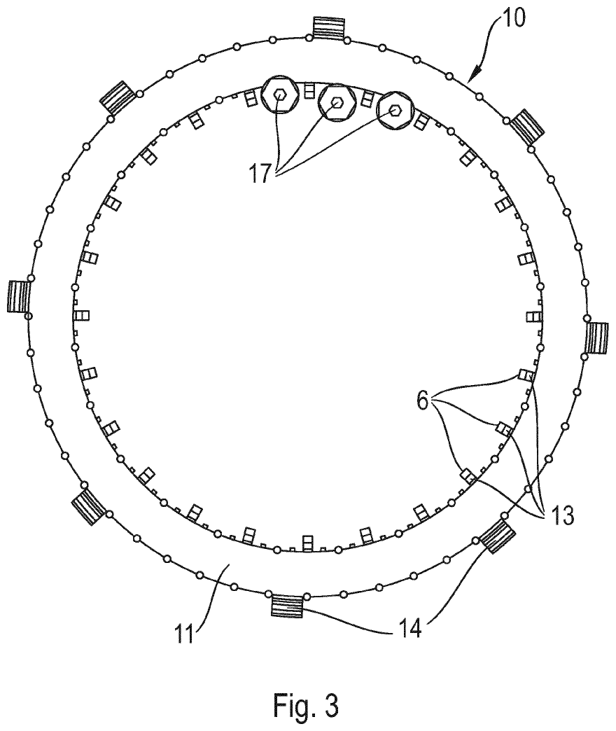

FIG. 3 shows an embodiment example of an interconnection 10 in a top view, i.e., from the side remote of the winding head 5, in which only the interconnection 10 and the connection pins 6 connected to it are shown. The supporting arms 14 protrude radially from the carrier 11.

In addition, power terminals 17 are provided at the inner circumferential surface that are electrically conductively connected to the respective connection conductors 12 and by which the connection conductors 12 are connected to power electronics, not shown, and supplied with electric current. The power terminals 17 are preferably formed analogous to the contact points 13 so as to be connected to a connection conductor 12 in each instance, these power terminals 17 having a larger cross section than the contact points 13. The power terminals 17 are arranged relatively close together to facilitate a connection via a plug or a shared cable if required. The power terminals 17 can also be provided depending on the installation space and arrangement of the connection conductors 12 in the interconnection 10 at the outer circumferential surface and/or the upper end face. In the depicted example, three power terminals 17 are shown for, e.g., a three-phase electric machine. The quantity of power terminals 17 can vary depending on the electric machine, in particular the quantity of phases or the maximum power that can be transmitted per power terminal 17.

The invention is not limited to the described embodiments. As stated above, advantageous features may be provided merely singularly, or various exemplary features may be combined.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. An interconnection for an electric machine with hairpin winding having a plurality of connection pins, wherein the interconnection comprises:
a plurality of connection conductors that each extend at least over a portion of a circumference;
a carrier that supports the plurality of connection conductors and at least insulates the plurality of connection conductors relative to one another; and
a respective connection conductor electrically conductively connected to each connection pin;
wherein the carrier comprises:
a plurality of supporting arms at an outer circumference thereof, the plurality of supporting arms are inclined relative to a radially extending plane and relative to a rotational axis of the electric machine, and
the plurality of supporting arms have clamping surfaces by which they are clampable between a housing or stator carrier and a bearing shield.

16. The interconnection according to claim 15, wherein the clamping surfaces are arranged parallel to or on a radially extending plane.

17. The interconnection according to claim 15, wherein at least some of the clamping surfaces have at least one projection, which is deformable to compensate for manufacturing tolerances during assembly.

18. The interconnection according to claim 15, wherein the plurality of connection conductors run coaxially or in axial direction parallel to one another.

19. The interconnection according to claim 15, wherein the plurality of connection conductors are formed annularly extending over an entire circumference.

20. The interconnection according to claim 15, wherein the plurality of connection conductors have respective contact points in a radially inner region or a radially outer region which protrude from the carrier for connecting to the connection pins.

21. The interconnection according to claim 20, wherein the contact points in each instance run axially parallel to a connection pin at least in a partial area.

22. The interconnection according to claim 15, wherein the carrier wraps around the plurality of connection conductors to form a positive engagement.

23. The interconnection according to claim 15, wherein the carrier is produced by overmolding the plurality of connection conductors.

24. An electric machine comprising:
a hairpin winding; and
an interconnection for the electric machine with the hairpin winding having a plurality of connection pins, wherein the interconnection comprises:
a plurality of connection conductors that each extend at least over a portion of a circumference;
a carrier that supports the plurality of connection conductors and at least insulates the plurality of connection conductors relative to one another;
a respective connection conductor is electrically conductively connected to each connection pin;
wherein the carrier comprises:
a plurality of supporting arms at an outer circumference thereof, the plurality of supporting arms are inclined relative to a radially extending plane and relative to a rotational axis of the electric machine, and
the plurality of supporting arms have clamping surfaces by which they are clampable between a housing or stator carrier and a bearing shield; and
the clamping surfaces are clamped between a housing or stator carrier and a bearing shield of the electric machine.

25. The electric machine according to claim 24, wherein
the hairpin winding has hairpin ends that are welded to one another,
the hairpin ends are covered by an insulating unit, and
the interconnection lies on the insulating unit.

26. A method for producing an electric machine, comprising
providing a hairpin winding;
positioning an interconnection on the hairpin winding, wherein the interconnection comprises:
a plurality of connection conductors that each extend at least over a portion of a circumference;
a carrier that supports the plurality of connection conductors and at least insulates the plurality of connection conductors relative to one another; and
a respective connection conductor electrically conductively connected to each connection pin;
wherein the carrier comprises:
a plurality of supporting arms at an outer circumference thereof, the plurality of supporting arms are inclined relative to a radially extending plane and relative to a rotational axis of the electric machine; and
the plurality of supporting arms have clamping surfaces by which they are clampable between a housing or stator carrier and a bearing shield;
positioning the plurality of supporting arms of the interconnection with their clamping surfaces on a housing or stator carrier;
connecting the connection pins to the plurality of connection conductors; and
mounting and connecting a bearing shield on the housing or stator carrier,
wherein the plurality of supporting arms are clamped with their clamping surfaces between the housing or stator carrier and the bearing shield.

27. The method according to claim 26, further comprising:
mounting an insulating unit on the hairpin winding before the interconnection,
wherein hairpin ends are positioned in the insulating unit and the connection pins are electrically conductively conducted to the interconnection axially through or past the insulating unit.

28. The method according to claim 26, wherein a potting compound is applied before or after mounting the interconnection in order to insulate hairpin ends.
